(19) United States
(12) Patent Application Publication
(10) Pub. No.: US 2003/0078934 A1
(43) Pub. Date: Apr. 24, 2003

(54) Dynamic content delivery system

(76) Inventors: David Cappellucci, Wayland, MA (US); Kirby Mansfield, Pepperell, MA (US); Sandeep Gupta, Somerville, MA (US)

Correspondence Address: MINTZ, LEVIN, COHN, FERRIS,, GLOVSKY and POPEO, P.C., One Financial Center, Boston, MA, 02111, US

(21) Appl. No.: 10/125,891

(22) Filed: Apr. 19, 2002

Related U.S. Application Data
(60) Provisional application No. 60/285,271, filed on Apr. 23, 2001.
(60) Provisional application No. 60/370,821, filed on Apr. 8, 2002.
(60) Provisional application No. 60/370,822, filed on Apr. 8, 2002.

(51) Int. Cl. G06F 7/00

(52) U.S. Cl. 707/101

(57) ABSTRACT

The present invention is directed to a scalable method and system for providing large groups of users with access to a large group of disparate information resources. The system is highly scalable and provide for a layered architecture that enables rapid application development, high availability and strong system security. The method and system can also provide the ability to customize the information provided by allowing the user to locate, assemble, format and combine information elements from diverse information resources in real time.

### CROSS-REFERENCE TO RELATED APPLICATIONS

This application claims the benefit of priority to U.S. Ser. No. 60/285,271 filed Apr. 23, 2001, entitled Methods and Systems for Providing Online Standards of Learning Data, U.S. Ser. No. (not yet known—Attorney Docket No. 02905.504) filed on Apr. 8, 2002, entitled Dynamic Content Delivery System and U.S. Ser. No. (not yet known—Attorney Docket No. 02905.503) filed on Apr. 8, 2002, entitled Method and System for Correlating a Plurality of Information Resources, all of which are incorporated herein by reference in their respective entirety.

This application is related to U.S. Ser. No. [not yet assigned—Attorney Docket No. 02905.505] filed on Apr. 19, 2002, entitled Method And System For Correlating A Plurality Of Information Resources and is hereby incorporated by reference.

### STATEMENT REGARDING FEDERALLY SPONSORED RESEARCH

Not Applicable

### REFERENCE TO MICROFICHE APPENDIX

Not Applicable

### BACKGROUND OF THE INVENTION

This invention relates to methods and systems for online standards based learning and, more particularly, to a method and system for accessing and assembling information elements from many large and diverse information resources and providing efficient delivery of the information to large groups of users.

Generally, computer systems are arranged and configured to enable users to obtain access to information and information resources. Depending upon the needs of the user, the information can be located by searching or using search tools. Typically, a user searches for information by presenting search criteria to the computer system which uses well known algorithms and processes to isolate the information that meets the search criteria. In some systems, the information is classified or associated with one or more criteria, for example information relating to mathematics, physics or chemistry and the user can limit their search to information within a specific classification in order to limit the search results to a more manageable size. In addition, the classification structure can be hierarchical, providing for many degrees of organization by providing many levels of sub-classification. However, these systems do not provide correlations or links between information resources, objects or elements of information resources. Thus, there is no way for one to know whether a particular information resource, object within the information resource or element within an information object is related in some way to another information resource, object or element.

One method of enabling users to find related information resources, objects or element is 15 to provide a correlation system such as a table which links each information resource, object or element to each other related information resource, object or element based upon predefined criterion. Thus, for example using educational information, mathematic information can be linked to other mathematic information and 5^{th} grade information can be linked to other 5^{th} grade information.

This simple direct linking system can be acceptable where a few information resources can be directly linked or related to each other. However, where many information resources need to linked or related, the mechanism for maintaining the correlation (the links and/or relations) between each information resource (and their objects and elements) becomes increasingly large and complex. For example, a system with N information resources would require N*(N−1)/2 resource correlations in order to link each resource to the N−1 remaining resources and each resource correlation can include at least one entry for each information resource object or element correlated. In addition to having to maintain N−1 resource correlations, the number of resource correlations increases by N with the addition of each new resource.

Each time a new information resource is added, each information object or element in that new resource must be linked to the information objects or elements of existing resources in N−1 new tables. Existing resources change as new information elements are added and others deleted. When these information objects are added to or deleted from existing resources, the N−1 correlation tables must be changed to reflect the additions or deletions. Such a system is inefficient to manage and lacks the ability to scale.

In addition, as the number of users and volume of information resources grow, the computer system used to provide access to the information must also grow or scale to meet the increasing user demand. Depending upon the user access profile, the system may need to scale in different ways to meet different types of load requirements.

One example of an environment which involves large numbers of users and large quantities of informational resources is the educational resource environment. For example, the state of Massachusetts can have a million potential users (administrators, teachers, students and parents) and many diverse resources of educational information. For purposes of illustration, a sample list of some of the types of educational resources that can be used in an online learning system can include: lesson plan resources, standards resources (State, district and school standards), assessment resources, professional development resources, student resources and textbook derived resources. In addition, in a typical system, it would not be uncommon to include many disparate information resources from each type.

An information resource typically includes one or more information objects which can include one or more information elements. In the education environment, for example, a lesson plan resource can include one or more lesson plans, which are made up of one or more activities; an assessment resource can include one or more examinations (tests) that are made up of one or more questions; and textbook derived resources can include one or more textbooks and each textbook can be further divided into sections, chapters, or even paragraphs, depending upon the degree of granularity desired.

It is desirable for all educators and students to have full and immediate access to all appropriate educational resources that are available to the system. For example, every year hundreds or thousands of teachers may teach a weeklong lesson on exponents in a Trigonometry course and each of those teachers might want to do some or all of the following:

Develop a lesson plan that fits the topic of exponents into a week-long schedule;

Pick and choose which activities should be part of the lesson plan;

Possibly substitute activities and related materials from outside sources;

Obtain teacher-oriented (professional development) materials that would show the best way to teach difficult concepts (these could be text, video, or audio);

Orient the lesson plan to cover certain state and district standards;

Develop a set of assessment tests to evaluate the student's knowledge of the topic both before and after the lesson.

Assuming the resources above are correlated and the tools are available to enable each educator to efficiently identify and locate the information resources and information objects and elements that each educator can use to develop the lesson plan, the system capable of supporting this endeavor must be sufficiently robust to support not only the teachers searching for the information, but also the ability to assemble, format and deliver all of the information, organized in a useful way, to all the users in a timely manner. In addition, it is desirable to give the user the ability to customize the information by changing information elements or combining information elements from diverse information resources.

Accordingly, it is an object of this invention to provide an improved method and system for providing user access to information resources.

### SUMMARY OF THE INVENTION

The present invention is directed to a method and system for providing large groups of users with access to information that is can be obtained from a large group of disparate information resources. In accordance with the invention, the method and system are scalable and provide for a layered architecture that enables rapid application development, high availability and strong system security. The method and system of the invention can also provide the ability to customize the information provided by allowing the user to locate, assemble, format and combine information elements from diverse information resources.

In accordance with the invention, the system includes a presentation tier, an application tier and a data tier. The presentation tier can be adapted for providing presentation services including providing an interface for system applications and application services to the user and for providing the information in a form that is useful to the user. The application tier can be adapted for providing application services including providing a platform for the development and execution of applications and tools that facilitate the users access to and manipulation of information provided by the system. The data tier can be adapted for providing data storage and retrieval services including transforming or formatting information. The data tier can include one or more data stores and can include a plurality of different types of data stores for storing information in different forms including relational databases, markup language databases and data file systems. The data tier can also provide data transformation and formatting services on data obtained from one or more of the data stores. Each of the tiers can be separately scalable to efficiently accommodate changes in system usage requirements.

The system can include a plurality of separate information resources, each information resource including a one or more of information objects (which can include one or more information elements), a reference information resource including a plurality of reference information elements, and a correlation system for correlating, validating, re-correlating and previewing the information objects or elements of the information resource with the reference information elements of the reference information resource. The system can also include a searching system that is adapted for locating and retrieving information objects and information elements that are correlated to one or more reference information elements or for locating and retrieving further information objects or information elements that are correlated to the same reference information element as one or more primary information objects or elements. The system information objects and elements can be customized by the user and both system and customized information objects and elements can be combined with other information objects and elements provided by the user to produce customized information objects and elements that can be made available to users of the system. The system can also be part of or include a delivery system for delivering information elements located and retrieved by the searching system. The system can further include a presentation system, which may or may not be part of the delivery system, which is adapted for presenting the information elements according an undefined or predefined style, format or template. The presentation system can be adapted to deliver the information to a browser, PDA or other end user or edge devices.

The system can include a plurality of separate educational information resources, each educational information resource including a plurality of educational information objects and educational information elements, an educational reference information resource including a plurality of reference information elements, such as for example, a set of master learning objectives, and a correlation system for correlating, validating, re-correlating and previewing the educational information objects and elements of the educational information resource with the reference information elements or learning objective of the reference information resource. The system can also include a searching system which is adapted for locating and retrieving educational information elements that are correlated to one or more learning objectives or for locating and retrieving further information objects or elements that are correlated to the same learning objective as one or more primary information objects or elements. The information objects and elements can be customized by the user and both system and customized information objects and elements can be combined with information objects and elements provided by the user to produce customized information objects and elements that can be made available to users of the system. The system can also be part of or include a delivery system for delivering educational information objects located and retrieved by the searching system. The system can further include a presentation system, which may or may not be part of the delivery system, which is adapted for presenting the educational information elements according an undefined or predefined style, format or template.

The educational information objects can, for example, include state standards, district standards, professional development objects, assessment objects such as tests, lesson plans, student resource objects, and textbooks. The master learning objectives can include a plurality of hierarchically organized levels of learning objectives. The hierarchy can be organized whereby higher levels include more general categories of educational subjects or learning objectives and lower levels include more specific categories of learning objectives. The delivery system can be adapted for delivering one or more information objects and/or elements to a user as a function of a correlation defined between a learning objective and an educational information element.

The system can allow users to develop and store information objects and elements developed by the use in the user's own private storage area. These information objects and elements can be used to produce customized information objects and elements which can be stored in one or more of the information resources available through the system. A user can develop a customized information object by combining system information objects and elements and information objects stored in the user's own private storage area. The system can combine various system and user developed objects and elements to produce a customized information object or element that is stored in one or more of the information resources and made available to other users or it can be stored in the user's private storage area. The system can also provide several output options, such as making the information object or element available at a user terminal or can be printed on any output device. In addition, both system and customized information objects and elements can also be delivered to a third party service provider, such as a printing service or material supply service, to provide further services, such as printing and binding, ordering supplies and materials for a hands on activity or creating model or prototype.

The delivery system can be adapted to customize the information objects delivered to the user as a function of any information available to the system. Information can be customized based upon a user profile which provides information about a user or criterion input by the user. The delivery system can also be adapted to localize the information objects delivered to the user as a function of any information available to the system. The system can be localized by focusing or limiting access to educational information resources that correspond to the user's location and state and district education standards as a function of information that identifies or corresponds to a user's location.

The method in accordance with the invention includes the presentation tier receiving requests for information from the user. The presentation tier processes the user requests and forwards them to the application tier which invokes the applications, tools and functions necessary to process the user request. The data tier can provide access to many different types of data stores and the application tier establishes connections with the various data stores as needed to find and retrieve information to be delivered to the users. The data tier can also transform and format data obtained from one or more of the data stores for presentation to the user. The application tier processes the user request and sends the result, which can include information from one or more of the data stores, to the presentation tier which can format the information and sends it to the user.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 is a diagrammatic view of a system in accordance with one embodiment of the invention;

FIG. 2 is a diagrammatic view of a presentation tier in accordance with one embodiment of the invention;

FIG. 3 is a flow chart of a process carried out by the presentation tier of FIG. 2 in accordance with one embodiment of the invention;

FIG. 4 is a diagrammatic view of a system in accordance with one embodiment of the invention;

FIG. 5 is a flow chart of a process carried out by the application tier of FIG. 4 in accordance with one embodiment of the invention;

FIG. 6 is a diagrammatic view of a system in accordance with one embodiment of the invention;

FIG. 7 is a diagrammatic view of a data model for educational information resources in accordance with one embodiment of the invention; and

FIG. 8 is a flow chart of a process for locating information in accordance with one embodiment of the invention.

### DETAILED DESCRIPTION OF THE PREFERRED EMBODIMENTS

The present invention is directed to a method and system that is adapted to be scalable, accommodate many information resources and provide many users with access to the information resources. The method and system can also be adapted for correlating, relating or linking information within an environment that derives information from a plurality of informational resources that can be disparate, unrelated and separated and order to facilitate finding and distributing information, or portions thereof, to many users. The method and system can provide for customization and localization by allowing information objects and elements and portions of information objects and elements to be selected and combined by the user to produce customized and localized information objects that contain information from diverse information resources. These information objects can be stored in their native format and delivered to large groups of users in real time.

While the method and system of the invention provide benefits for systems that are adapted for delivering information to users, the invention can also be used in methods and systems for storing information. In order to facilitate a better understanding of the invention, the invention below is described below in one or more illustrative examples or embodiments.

In accordance with one embodiment of the invention, a system for providing educational information to a large group of users, including administrators, teachers, students and parents, can be arranged into tiers that correspond to functionality. In accordance with this embodiment of the invention, the system can include a presentation tier, an application tier and a data tier. The presentation tier can provide presentation services for managing the interface between the system and the user, receipt of information from the user and the presentation of information to the user. The application tier can provide application services for supporting the execution of applications and the business processes of the system. The application tier can also interface and interact with the data tier to manage access to and the manipulation of information to be delivered to the user. The data tier can provide data management services including controlling access to information stored many formats and providing data formatting, translation and conversion services.

The system can allow users to access educational information according to the user's needs. For example, a teacher can create or customize a lesson plan by locating and assembling one or more activities, assignments, and reading materials that correspond to the learning objective of the lesson. The teacher can also locate and retrieve supplementary information about one or more subjects taught in the lesson for purposes of professional development or remedial learning of her students. The system can use information, such as a teacher's profile or school district information, to localize the system to focus access to educational information resources that correspond to the teacher's state and district education standards. The system can use information in a student's profile to customize the user interface and information provided to the student. For example, the system can provide larger fonts and bright colors to keep the attention of students in grades kindergarten through two or the system can automatically provide easier activities or assignments to below average students.

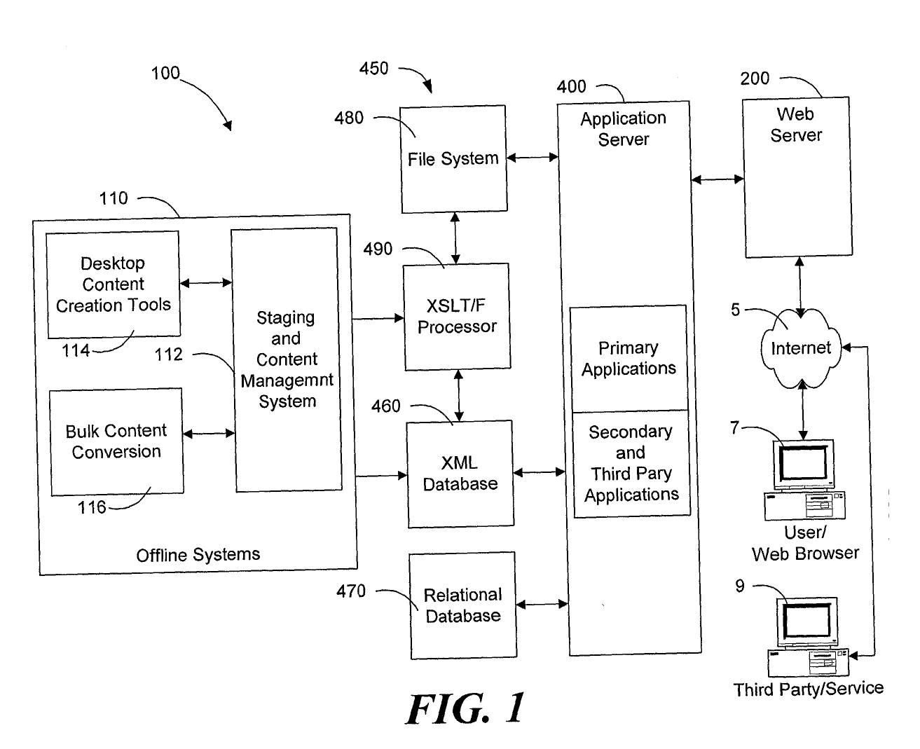

FIG. 1 shows a diagrammatic view of a system 100 in accordance with one embodiment of the invention. The system 100 can include a three tier architecture including a presentation tier which can include a web server 200, the application tier which can include an application server 400 and the data tier 450 which can include one or more data stores, such as a native XML database 460, a relational database 470 and a file system 480. The data tier can also include an information translation and formatting engine 490 adapted for formatting and translating information used by the system 100.

The presentation tier can provide an interface between the user and the user's computer and the applications of the application layer. In one embodiment, the presentation tier can include a web server 200 which can communicate with users using HTTP to transfer over the Internet 5 user requests and web pages between the system and the user's browser at the user's computer 7. The presentation tier can also include other subsystems and servers (not shown) for communicating with other devices and systems. These devices and systems can include other user devices, such as personal digital assistants (PDAs), Wireless Application Protocol (WAP) compliant devices and Blue Tooth compliant devices, and third party systems and service providers 9 in order to make third party products and services available to users. As one of ordinary skill would appreciate, the subsystems for communicating with third party systems and services can be included in the application tier or provided as a separate service layer or component which interfaces directly with the application tier and is separate from the presentation tier.

The application server 400 can provide a platform for the development and execution of the business logic and functionality associated with the various business processes and tasks to be carried out by the system 100. The business processes and tasks include the processes and functions that make up the operation of the system. The business logic and functionality can be implemented in a set applications. The business logic and functionality can be changed by modifying or adding applications These applications can include methods or processes that are executed in response to user input, received by the presentation tier, and that provide the information objects and elements that can be transferred to the user by the presentation tier. In one embodiment, the educational information objects and elements can be assembled (and optionally translated or formatted) into a document or set of documents that can be transferred to the user. The documents can be provided in the form of web pages (HTML documents) or other formats such as Adobe Systems, Inc. (San Jose, Calif.) portable document format (pdf). The information objects and elements can also include audio and video components that be delivered in streaming form and listened to or viewed by the user at a computer or downloaded and listened or viewed on any capable device at a later period in time.

The system 100 can also include an offline system 110 to facilitate management of the information stored by the system 100. The offline systems 110 can include an XML content management system 112 for managing (adding, deleting, changing) the information stored in the XML data stores. The offline system 110 can also include content creation tools 114 which can facilitate the creation of information objects, elements and resources that can be added to the system 100 and bulk content conversion tools 116 to permit bulk content, such as textbook based information, to be converted to a form that can be used by the system 100.

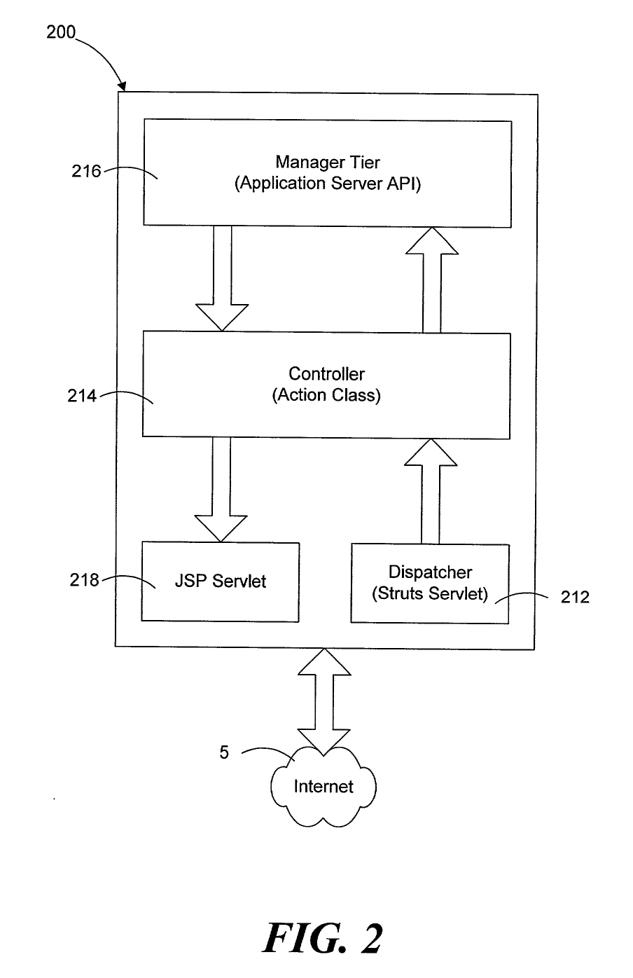

FIG. 2 shows a diagrammatic view of one embodiment of the invention which includes a web server 200 as part of the presentation tier. The web server 200 can include a dispatcher 212, such as a Struts Servlet, (part of the Struts Framework available from the Jakarta Project of the Apache Software Foundation, Forest Hill, Md.,) for receiving an http request from the user 7 over the Internet 5, a controller 214, such as an action handler or class, for interacting with the manager tier 216 to invoke the applications and methods, a manager tier 216 providing an application programming interface (API) to the application tier (not shown) and a Java Server Pages (JSP) Servlet for translating the information produced by the application tier into HTML pages to be sent over the Internet 5 to the user 7. The HTML pages sent to the user 7 can also be used to present to the user more interactive content, such as streaming audio or video and to enable the user to view and download information objects.

The same system 100 can use other technologies to communicate or interface with third party systems and service providers 9 to provide users with access to third party products and services. Instead of preparing and sending an HTML page, the JSP Servlet 218 (or another server) can send a communication, such as an email message to a third party system, such as a professional printing service, to place an order to have an attached or remotely accessed document (or other publication) printed and bound and delivered to a user. Alternatively, the JSP Servlet 218 (or another server) can interface directly with the third party system to place the order automatically.

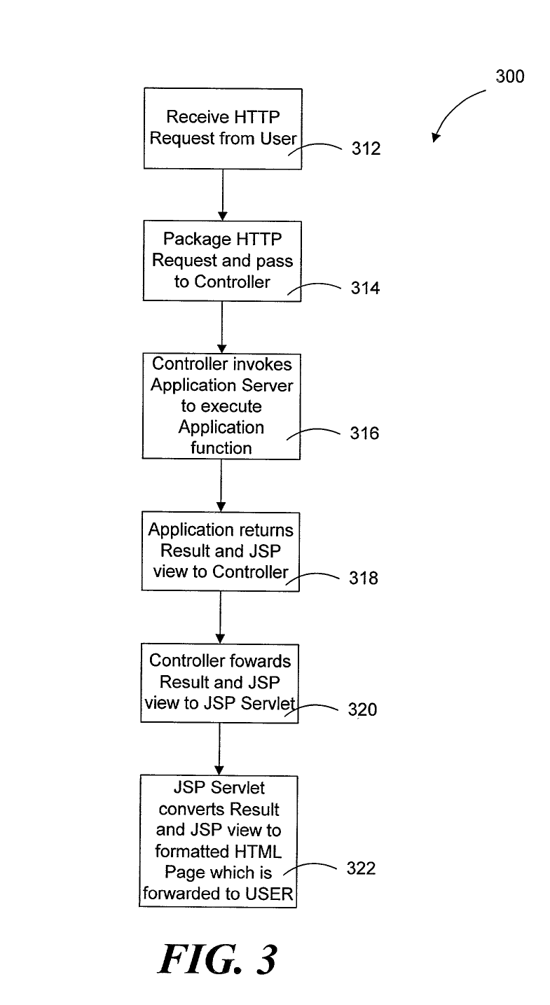

FIG. 3 shows a flow chart of a method of processing information within the presentation tier in accordance with one embodiment of the invention. When the user 7 clicks on a button or a link in a web page, the user's browser sends an HTTP request which is received by the web server 200 at step 312. The dispatcher 212 can use an XML configuration file and reflection to package up the HTTP request in a form class and pass the form class to the controller 214 at step 314. The controller 214 can use the form class to invoke the application server (not shown) via the application server business API to initiate a process or a function in the application tier at step 316 The application server returns a result to the controller 214 in step 318 and the controller 214 forwards the result and a the appropriate JSP view to the JSP Servlet 218 in step 320. In step 322, the JSP Servlet uses the Result and the JSP view to produce a formatted HTML page which is forwarded to the user.

In accordance with this embodiment of the invention, the web server 200 can include one or more SUN Solaris based computers from SUN Microsystems, Palo Alto Calif. The computers can be arranged in a web server farm or cluster configuration in order to facilitate scalability to accommodate hundreds of thousands or millions of users. In this embodiment, the web server farm or cluster can be located behind a firewall and include conventional backup and fail-over systems and load balancing systems. Alternatively, the web server can be one or more Windows based PC compatible computers, based upon the Intel Corporation (Santa Clara, Calif.) family of microprocessors and the Microsoft Corporation (Redmond, Wash.) Windows operating system including the Windows Internet Information Server and Transaction Server platforms.

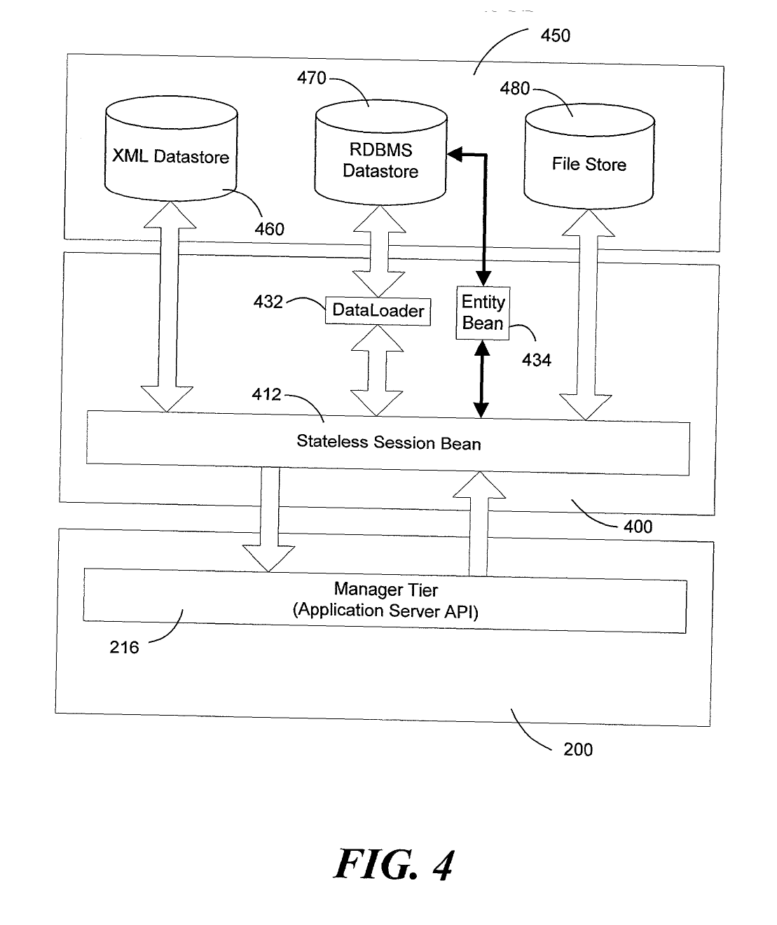

FIG. 4 shows a diagrammatic view of one embodiment of the invention which includes an application server 400 as part of the application tier and a plurality of data stores in a data tier 450. The application server 400 can include one or more application components 412 and 434 which are adapted to execute the business processes and logic associated with the application functions. The data tier 450 can include many diverse data stores, such as those shown in FIG. 4. The data stores can include one or more native XML databases 460, one or more relational databases 470, one or more data file systems 480 and an information formatting and/or translating system (not shown, see item 490 in FIG. 1).

In accordance with this embodiment of the invention, the application server can include one or more SUN Java 2 Enterprise Edition (J2EE) framework based computer systems. The computers can be arranged in an application server farm or cluster configuration in order to facilitate scalability to accommodate hundreds of thousands or millions of users. In this embodiment, the application server farm or cluster can be located behind a firewall and include conventional backup and fail-over systems and load balancing systems. The application server can include one or more application platforms such as BEA Weblogic from BEA Systems, Inc of San Jose, Calif., SUN's ONE (formerly iPlanet), IBM's Websphere, SUN Enterprise Java Beans (EJB), SUN Java Database Connectivity (JDBC) and other components of the Sun J2EE framework. Alternatively, the application server can be one or more Windows based PC compatible computers, based upon the Intel Corporation family of microprocessors and the Microsoft Windows operating system including the Windows Internet Information Server and Transaction Server platforms or the SUN EJB application platform..

In accordance with the invention, the data tier can include many data stores. Each data store can include a plurality of computers, such as SUN Solaris computers systems, arranged in a farm or cluster configuration in order to facilitate scalability to accommodate large quantities of data and users. Each data store server farm or cluster can be located behind a firewall and include conventional backup and fail-over systems and load balancing systems. In accordance with one embodiment of the invention, the data tier can include the following data stores: a highly scalable, high performance native XML database such as Tamino (available from Software AG, Darmstadt, Germany), a highly scalable, high performance relational database such as Oracle (available from Oracle Corp, Redwood Shores, Calif.), a Lightweight Directory Access Protocol (LDAP) compatible database such as and a highly scalable, high performance file system such as the SUN Solaris file system or the Microsoft Windows NT File System.

Other database systems can be used to store and provide access to information, depending upon the requirements and the structure of the information. Preferably, the data stores provide access to information organized in a high degree of granularity at a high level of data access performance. Higher levels of information granularity can improve the custom publishing capabilities of the system by permitting the user to select smaller elemental units of information from the diverse information resources to be assembled into customized lesson plans, assessment and other educational materials. Therefore it is desirable that the database systems have the ability to provide high performance access to very granular information.

In one embodiment, the system can include open standard technologies, such as XML data stores which can be accessed using XPath, XSLT, XFO, XML schemas, LDAP, WebDAP, and SOAP technologies. These technologies can be used to search, format, translate and correlate the information stored in the information resources and facilitate the delivery of the information to the user.

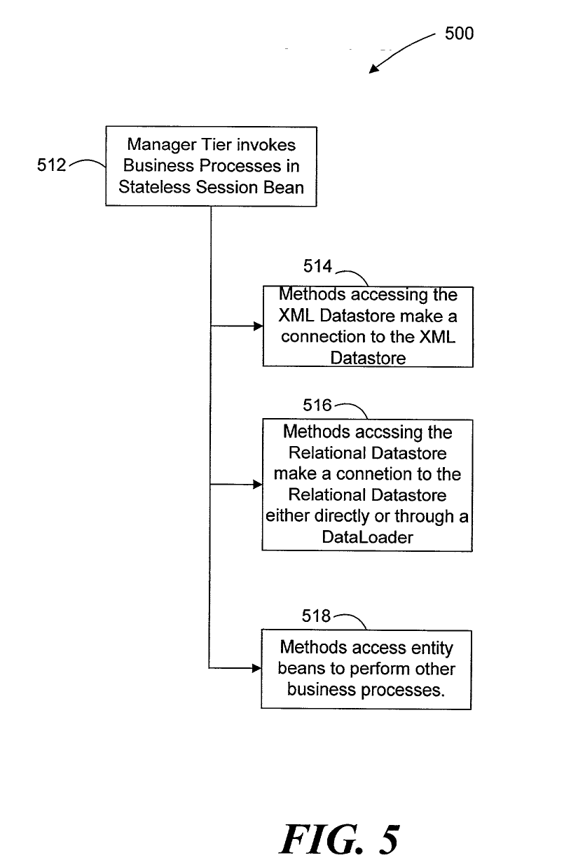

FIG. 5 shows a flow chart of a method of processing information within the application tier in accordance with one embodiment of the invention. The manager 216 in the Web Server makes application calls to the application programs or components in the application tier at step 512. These application calls, via the application server API, invoke the business methods and programs that execute the business processes at steps 514, 516 and 518. Methods that need access to information in the XML data store can make a connection to the XML database server at step 514 either directly, using http or via any database connectivity framework supported by the database. Methods that need access to information in a relational database can access the database directly or access the data base through a dataloader or database connectivity framework such as JDBC, at step 516, depending upon the configuration of the database. Methods can also access other methods and processes at step 518 which can be managed by the application server. In one embodiment of the invention, the application platform is a SUN Microsystems J2EE platform -and can include one or more pools of stateless session beans adapted to establish connections with the databases and the dataloader and one or more entity beans adapted for performing business processes. The Session beans can provide a central location for business processes and the processes can broken down into discrete sets of services. A Java Database Connectivity (JDBC) component can also be used to connect to and access databases in the Data tier.

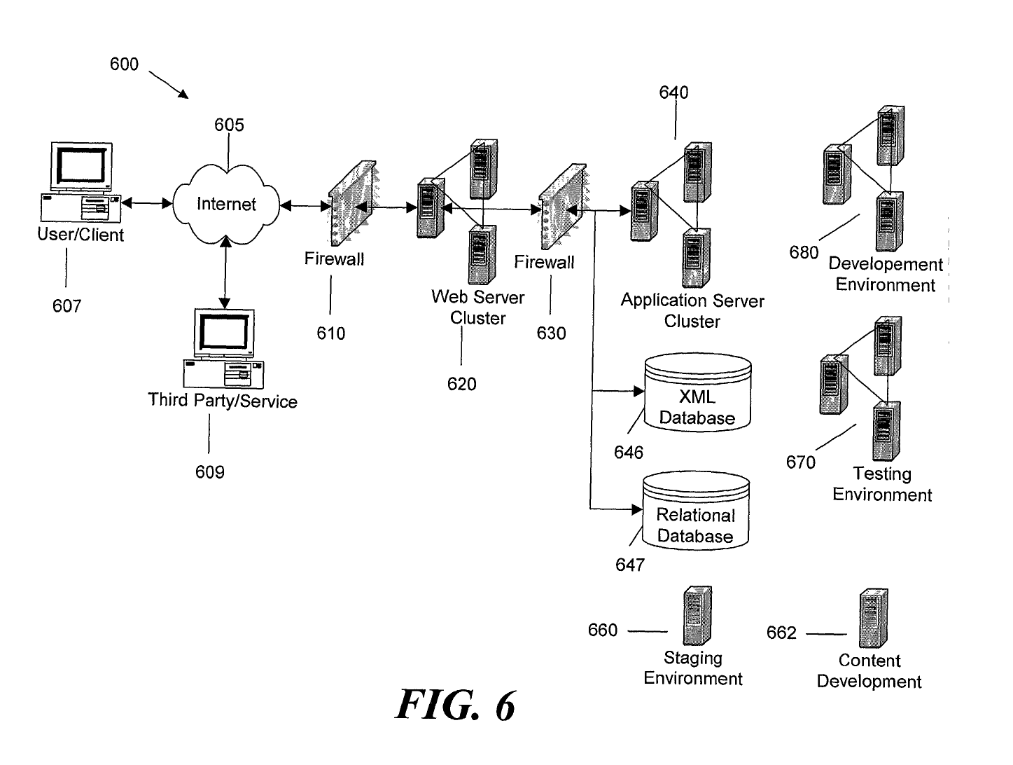

FIG. 6 is a diagrammatic view of a system 600 in accordance with one embodiment of the invention. The system 600 can be connected though a firewall 610 to a user at a client computer 607 via the internet 605. The web server cluster 620 provides the presentation services and allows the user 607 to interface with the system. Web server 620 can receive requests from and send html web pages via http to the client 607. The web server 620 can also be adapted to change the form of the information sent to the client 607 to accommodate user client device requirements such as wireless devices (via WAP) or user accessibility requirements (for the visually or hearing impaired). The Web Server 620 can be connected through a firewall 630 to the Application Server Cluster 640, and the XML database 646 and relational database 647 can be connected to the Application Server 640 behind the firewall 630. The system 600 can also include additional systems for development and testing purposes. A content development system 662 can be provided for the development of information elements and information resources as well as provide facilities, such as a staging environment 660, for the conversion of bulk content to be imported into the system. The system 600 can further include a development environment 680 for the development of new application components, tools and methods and a testing environment 670 for testing the newly developed components, tools and methods.

The system 600 can allow users to create customized information objects and elements by allowing a user to modify an existing information object or element, add a new information object or element to the system 600 and allow the user to combine existing system information objects and elements with modified information objects and elements and new information objects and elements added by a user at the client computer 607. Typically, all information objects and elements available from the system can be presented to a user at the user's computer 607 or printed on a user's printer (not shown) or a system printer (not shown). In addition, the system 600 can also be adapted to send information objects and elements to third parties 609 that can provide support services to a user 607. The third party services can be printing services, such as provided by KINKO's Inc, Ventura, Calif. at KINKOS.COM, for example, for printing and binding of a workbook or an activity. The third party services can also be suppliers of materials or other services available to a user and for example, a lesson plan that requires shapes or paint or shop supplies (wood, screws or glue) could be used to generate an order to have these materials delivered to the teacher or generate a request to borrow an instructional video tape or other visual aid. The system 600 can be adapted to interface with third party systems to facilitate access to the third party services. In this regard, the system 600 interface can be as simple as the web server 620 or the application server 640 sending an email message to a third party, to request that an attached (or remotely accessible) file be printed and bound or be highly integrated with a third party ordering system to electronically generate a product or service order. In this regard, system 600 can include additional servers and components (not shown) and use various well known and proprietary protocols and techniques to facilitate the communication with third parties 609.

System 600 can include a distributed architecture which includes the various software components distributed over various hardware components and well known distributed architecture communication protocols and remote access technologies to enable the system 600 to operate in an integrated fashion. These protocols and techniques can include EJB remote method invocation, CORBA, SOAP, HTTP and HTTPS, JDBC, JNDI, WebDAV and TCP/IP based proprietary protocols. These protocols can also be used to allow the system 600 to communicate with legacy systems and external resources.

In accordance with one embodiment of the invention, the system 600 of the invention can be as part of an online learning or e-learning system. Educational information resources can be stored in the data stores 646 and 647 of the data tier and used to provide content for the online learning system. Preferably, the educational information that takes the form of textual information can be stored in native XML format in the XML database 646. This information can include:

1. Lesson Plans—A lesson plan is a teacher's schedule for teaching a set of learning objectives. Lesson plans can range from short term (5 days) to long term (semester). Long-term lesson plans are also called scope sessions. Lesson plans can include day-to-day or week-to-week objectives, activities, questions, teaching strategies, or class-grouping suggestions. In addition, the elemental units that make up a lesson plan including activities and assignments can be included in this category.

2. Standards—National, State, district and school standards are listings of learning objectives broken by categories, such as grade-level and subject category. The state standards and objectives are typically high level. It is up to the individual districts and schools to make each learning objective into more detailed sets of learning objectives and curriculums.

3. Assessments—In order to test the student body's grasp of the state and/or district standards, assessments can be given by teachers, schools, districts or states. The time period for such assessments may cover years, semesters, or even weeks. The assessment may also cover a particular activity or unit of teaching or learning objective. Assessment functionality includes the ability to rate the performance of a student against statistical performance data and against any required standards. Preferably, deficient areas of study will become evident after an assessment. In addition, the elemental units that make up an assessment test questions and answer sets can be included in this category.

4. Professional Development—refers to the resources that aid a teacher in understanding or teaching a concept or a course. Sometimes such resources may show the teacher a clever way to teach a particular concept. Some resources can include entire mini-courses, designed to refresh the teacher on the concepts that they will be teaching. For example, a video (vignette) that shows how to prepare an in-class demonstration on magnetism using solenoids.

5. Student Resources—can include any material, regardless of form, that aids a student in understanding a concept. This material can include reading material, exercises, physical objects or experiments or an interactive computer program. Often these resources are taken home for the purposes of remedial learning.

6. Text Books—are the paperbound legacy data store with which most students are familiar. Textbooks can be stored in an electronic form. One disadvantage of textbooks is determining how to break the textbook down into logical learning units. Sometimes these units will parallel the sections, paragraphs, and/or chapters of a book and sometime they will not. However, once a textbook is formatted in XML, the content contained therein can be more easily evaluated to determine logical learning units.

7. Other resources—these include other online systems such as the World Wide Web (WWW) and the Internet in general that can be a resource for educational information. This can also include user private information objects and elements. Preferably, these resources can be pre-qualified and an interface can be developed to allow the system to interact with and access the information available through these types of resources.

It should be noted that in a typical system, it would not be uncommon to provide many educational information resources from a single type of resource listed above and in general, many educational information resources from may, if not all, of the resource types. For example, there will typically be at least two educational standards resources, the state standard and one or more district (and local) standards associated with a given system as well as many different assessment, textbook and lesson plan resources in the given system. The system can be flexible to allow the use of new information resources that do not fall within the types listed above. New types of information resources can be defined within the system as need to allow the system to expand to accommodate new information resources.

Preferably, the information resources can be correlated as disclosed in commonly owned, U.S. patent application Ser. No. [not yet assigned—attorney docket no. 02905.505], filed on Apr. 19, 2002, entitled Method And System For Correlating A Plurality Of Information Resources which is incorporated by reference herein. Alternatively, the information can be correlated by any known method or system. The correlation system allows the information elements of each information resource to be linked or related in order to make it easier to identify and find additional information elements about the same or related topics or subjects.

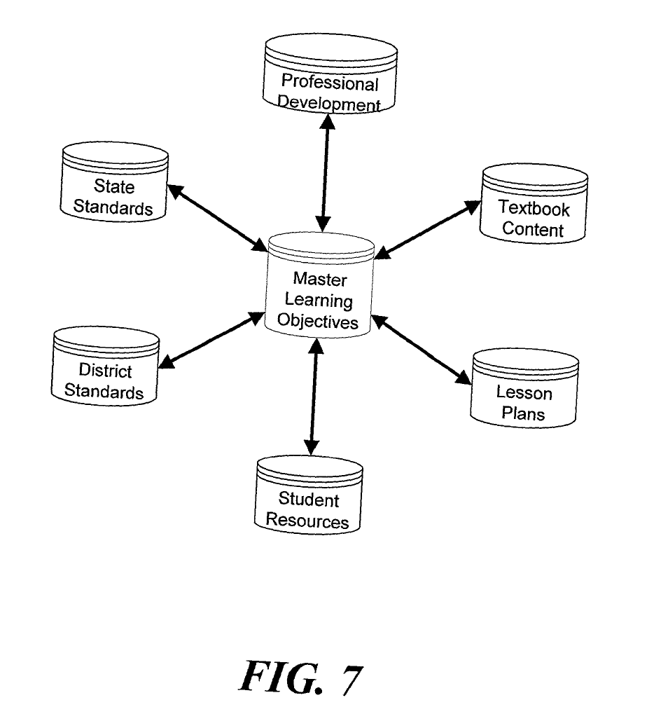

FIG. 7 shows a diagram of a system in accordance with on embodiment of the invention for establishing correlations between a plurality of informational resources that can be disparate, unrelated and separated. These information resources, as discussed herein, can by divided into categories or types such as lesson plans, standards—State, district and school standards, assessments, professional development materials, student resources, and text Books

It should be noted that in a typical system, it would not be uncommon to provide many educational information resources from each of the types listed above. For example, there will typically be at least two educational standards resources, the state standard and one or more district (and local) standards associated with a given system as well as many different assessment, textbook and lesson plan resources in the given system.

FIG. 7 shows information resources linked or correlated to a central or reference information resource which is embodied in a set of master learning objectives (“MLOs”). The MLOs help the system to be efficient and scalable because they enable the system to more easily modified. As a practical matter, state and district standards, assessment, textbooks and lesson plans can change over time, thus making the free form correlation based system time consuming and difficult to maintain. In accordance with the invention, the MLOs provide a system that is not subject to these disadvantages. However, is should be noted that one disadvantage of the MLO based system is that is requires a level of indirection: all resource elements are not linked directed to each other, but indirectly via an MLO. This provides some inefficiency and possibly some limitation on accuracy.

Preferably, the MLOs are static, comprehensive and sufficiently granular to meet the goals of the system. Because all of the other information resources are referenced to the MLOs, it is desirable that the MLOs are static and do not change, often, if at all. The MLOs should be comprehensive in that the scope of information covered within the MLO structure is broad enough to include all the information objects and elements of each information resource. Preferably, the MLOs are arranged hierarchically with higher levels corresponding to more general categories of learning objectives and lower levels corresponding to more specific categories of learning objectives. In addition, the MLOs should be sufficiently granular to accurately correlate the various information objects and elements from the diverse information resources. In one embodiment, at the lowest level, the learning objectives can be considered the singular atomic unit of knowledge or learning and sufficiently specific and detailed to correlate to the most granular educational information element in the system. Thus, the MLOs are comprehensive in that there sufficient categories provide a broad scope and accurate in that they are specifically detailed in order to correlate or correspond to most detailed or specific information element from the information resources.

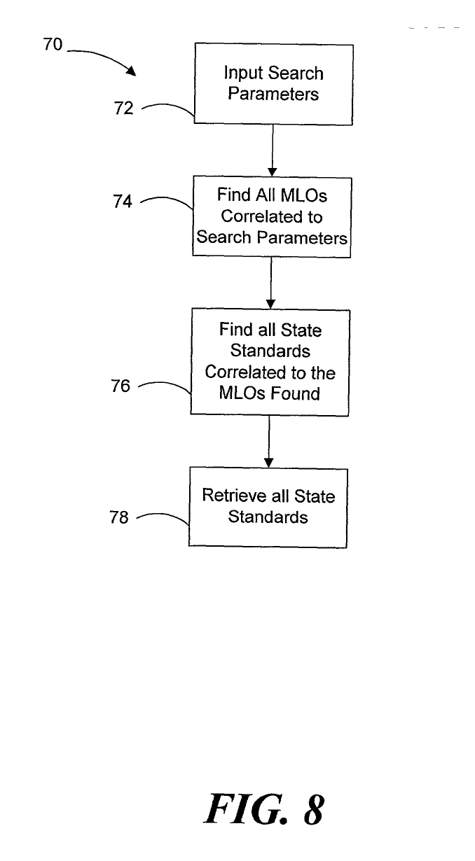

FIG. 8 shows an example of a method of finding correlated resources in accordance with the present invention. The information resources can exist in many different forms and may be stored in various manners (from DB, to flat file, to XML), however all share one thing in common—they all can be referenced with meta-data that will correlate them to the central database of the MLOs.

In one embodiment, the MLOs are a comprehensive and granular list of individual learning objectives that can be represented in a common set of meta-data elements for all information resources. Using the MLOs the information objects and elements of the different information resources can be correlated against each other.

For example, a lesson plan on lasers and holograms can be correlated to a MLO called “Science.Physics.Optics.Lasers.” At the same time, a book on lasers by Dr. Spock can be correlated against ..Science.Physics.Optics.Lasers” and a professional development item can be correlated against .‘Science.Physics.Optics.Lasers.” Because of these correlations, a teacher finding the lesson plan will be able to immediately find what resources will help her teach this subject, from professional development resources, to textbooks, to student resources. The educational information resources (or assets) are not directly linked to the lesson plan. The MLOs can be at the center of all correlations between a given resource and the other resources in the system. In addition each of the activities within the lesson plan can also be correlated to the MLOs. This imparts a higher level of granularity to the system by allowing a user to locate utilize information elements, as opposed to whole information objects (which can include more than one information element). Thus, the activity covering lasers in the lesson plan on lasers and holograms can be used to find the section or the chapter in the book by Dr. Spock that discusses lasers and the activity covering holograms in the lesson plan can be used to find the section or chapter that discusses holograms.

Preferably the MLOs are assembled into hierarchies. At the top of an MLO hierarchy is a general subject area. Each level down in the hierarchy can narrow down the topic/subject. For example, Physics can be a child node under Science, and Optics can be a child node under Physics, forming a tree that narrows the scope of the learning objective as we traverse down the tree and organizing the learning objectives into hierarchical topologies. Preferably, at the bottom of the tree are the most granular and atomic of learning objectives and usually take on the form of a description of what a student should know: “Student knows the difference between constructive and destructive interference in holographic imaging.”

An MLO can be ANY node on the tree. This includes topic nodes all the way down, so that science is an MLO, as is Science.Physics as is Science.Physics.Optics.Lasers.Holograms. Information resources are generally correlated as close to the leaf-node MLOs as possible. For instance, the lesson plan on lasers and holograms can be correlated to the MLO: Science.Physics.Optics.Lasers.Holograms. Student knows the difference between constructive and destructive interference in holographic imaging. However, an information element of any information resource can be correlated to any node including non-leaf nodes.

FIG. 8 shows a flowchart of a simple process 70 for performing a correlation query. A correlation query is a process to find those information elements that are correlated against a particular information element. For example, finding State Standards that are correlated to lesson Plan. The process includes the steps of entering the search parameters that form the basis of the search at 72. The parameters can include an identification of the lesson plan and the indication that the results should be from information resources containing state standards. In step 74, the system finds all MLOs correlated against the input information element (in our example the lesson plan). In step 76, the system finds all information element correlated against all MLOs found in step 74 which are State Standards and in step 78 the system retrieves the information elements, the State Standards we were searching for.

The process of FIG. 8 can become problematic when no correlations are defined for the search parameters or no state standards are correlated to the MLOs found in step 74. Alternative processes can be provided which address the problem where no correlations are defined for the search parameters.

One of the benefits of the present invention is that information stored in the data stores can be located, retrieved, assembled into an information object, such as a document or a web page and delivered to the user in or near real time and typically, in less than 0.2 seconds. The information object can be a test or a workbook or a set of homework or class work assignments that were previously selected by a teacher. The information objects can be standard information objects created for use within the system 600 or they can be customized, assembled from elements extracted from several standard information objects by the user.

For example, a teacher can examine a standard information object and find that some or all of the elements of the information object do not meet the needs of her students. The teacher can use that standard information object as a template to create a customized version of the information object. The customized information object can be derived from one of the standard tests, workbooks or assignments provided by the system 600. The various information elements and other components can be selected by teacher from various other information objects from any of the educational information resources available within the system 600 and combined into a customized information object that can added to the system. The customized information object can be stored as a new information object in the system or it can be stored as set of instructions or pointers which allow the object to be recreated from the other information objects and information elements.

In addition, the system 600 can include an object creation application that allows a user to create an information object, such as a lesson plan, an assessment or a workbook. The information can be entered into the system manually, such as via a keyboard, or extracted from exiting text and graphical resources. The new information object can be created from all user provided information or a combination of existing system information objects and user information.

In operation, the system 600 can include one or more lesson plan resources that include one or more standard lesson plans. A teacher seeking to develop a lesson plan can use the system 600 to search for lesson plan objects by national, state or district standards as well as key words. The system 600 can locate and provide to the teacher one or more lesson plans that meet her criteria. The teacher can also use the system 600 to review each of the activities or information elements that make up the lesson plan. If the lesson plan suits the teacher's needs, the teacher can add the lesson plan to her plan book. If the teacher finds that some of the activities of the lesson plan are not suited for her class, she can use the system to locate other activities that may be more suitable. The system 600 can locate the other similar activities by searching for activities that are correlated to the same or similar MLOs as the activity the teacher is seeking to replace. In addition, the MLOs can correlate to other informational dimensions, for example, they can indicate that the information object or element is suitable for visually impaired students or students where English is their second language.

If the teacher does not find an activity that is suitable, she can use the closest acceptable activity and adapt it or customize it to meet her needs. The system 600 can provide custom publishing tools that enable a user to revise and customize information objects and element. The revised or customized information objects and elements can be saved as new information objects and elements of the system 600 for access by other users.

After the teacher has selected the activities for her customized lesson plan, the lesson plan can be stored in the system as a new lesson plan. The lesson plan can be correlated to the same MLOs as the lesson plan from which it was derived. Depending upon the system constraints, the new lesson plan can be stored in the system in different ways. Where it is desirable to deliver the information at high speed and where memory storage capacity is not constrained, the lesson plan can be stored as a complete, new lesson plan. Where memory storage capacity is constrained and content delivery speed is less of a concern, the lesson plan can be stored as a set of instructions that allow it to be assembled from existing information objects and elements as needed.

After the teacher has created and stored her customized lesson plan or activity, she can print out that lesson plan on a local printer or email it to another teacher or administrator. The teacher can also arrange, using a system according to the invention, to have the customized lesson plan or an activity workbook printed by a third party printing service, such as KINKO's Inc. The teacher can retrieve the information object, the lesson plan (a set of lesson plans or a scope session), an activity workbook, an examination, or some remedial materials, and select the output options. These options can include, for example, sending them to another user, printing them on a local or system printer or arranging to use the services of a third party to print and binding service. If the user selects email, the application server invokes an email application that allows the user to email the information object to another user. If the user selects print, the application server invokes a print application that facilitates printing of the information object to a local or system printer.

If the user selects a third party service option, the system invokes an application that gets the necessary information from the user and other system resources in order to access the third party services. For example, where a teacher wants to have 25 copies of a workbook printed and bound, the system application would ask the teacher for the number of copies, the format and size of the printed workbooks, when the teacher needs them and any other information the third party may need. This information can be communicated to the third party service provider for a quote or if prior arrangements have been made, the order is automatically placed and the printed and bound workbooks are delivered to the teacher. Alternatively, the system can place an order for supplies and materials from third party, such as wood or plastic from a materials supplier for a shop activity or an instructional video, CD-ROM or computer program from a local, district or state repository for such resources. As one of ordinary skill will appreciate, the system of the invention can be used to obtain not only customized materials (lesson plans and instructional videos) but also to order standard materials and content from providers of these materials and content.

In one embodiment of the invention, the advantages of the system can be achieved by providing a tiered architecture in combination with a data store that store information objects in a format that is both easily accesses and formatted for delivery to the user in its native form and can also be tagged or otherwise structured to allow the information elements, the fundamental units of the information objects to be separately identified. Thus, for example, the use of a native XML data store, such as the Tamino XML database enables the system to quickly retrieve and format information objects for delivery to the users using XSL technologies and enables the system to search the XML data as if it were a database using X-path technologies. In addition, the information objects can be customized through the use of XSL technologies, that can filter and assemble information objects to produce customized information objects.

The system 600 can also include user information profiles that enable the system to customize, localize and personalize the information provide to the user. The user information profiles can include information that is unique to the user, for example, a student's location (state and school district), grade level (1^{st} or 2^{nd} grade), the student's achievement levels in various subjects (A student in math and a C student in English) or a teacher's location (state and school district) and subject or subjects taught (2^{nd} grade or math or science). This information can be used to select information that is presented to a user and how that information is presented to a user. For example, the achievement levels in a student profile can be used to filter questions in a practice assessment test delivered to a student; the system can filter out the easier questions from a test presented to a student having a higher level of achievement and filter out the more difficult questions from a test presented to a student having a lower level of achievement. The system can select different presentation format for students depending upon grade level, for example, students from grades 1-3 can be provided with a presentation format that uses larger fonts and bolder colors than would be used for grades 4-6. Note, however, students in grades 3 and 4, for example, may receive the same informational content, but it will appear different on each student's computer.

The system can also localize the information based upon additional information obtained by external sources that is not included in the user profile. For example, the system can evaluate the user's Information Service Provider (ISP) or source IP address to determine the location of the user in order to localize the information presented. For example, the system can determine whether to use a French language user interface and information or an English language user interface and information depending upon whether the user's ISP or source IP address is located in a French or English locale in Canada; Or the system may send provide a teacher with different lesson plans because a lesson plan which includes counting snowballs may create problems for teachers in southern climates which don't receive any snow. This system 600 can use the filtering capabilities of XSL to filter the information objects in order to control which information objects can be delivered to each user.

In an alternative embodiment, the system 600 can be used to deliver other kinds of information to a user. System 600 can used in any environment in which it is desirable to enable to the user to customize the information that many users can obtain access to.

For example, the system in accordance to the present invention can be used to provide customized news information from many diverse news information resources to a diverse user base. News information can be stored in native XML data stores and user profiles, identifying user preferences and attributes can be stored in an XML, relational or LDAP database and used to customize the news information delivered to a many users. The system can be used to deliver information from many diverse news information resources to many diverse consumers as a function of user profiles and be scaled to accommodate the growth of both the user base and the number of information resources. The system can, for example, search many news information resources for news as a function of preferences, attributes and other found in the user's profile, such as sports and local news, locate the information, assemble and format the information in to an undefined or user defined form and present it to the user. The system can further monitor which of the information objects presented to the user were actually viewed by the user and these selections can be used to further modify the user's profile based upon the categories and attributes of the information objects selected by the user. In addition, the user can also assess the information presented in order provide the system with feedback as to the relevance and interest of the news information provided to the user. The user feedback and category information associated with the news information objects can be used to update or modify the user's profile in order to further customize the news information provided to the user. The user's profile information and feedback information can also be correlated to advertising information in order to provide targeted advertising to users as well as assess the effectiveness of the advertising.

In another example, the system can be used to provide audio (such as music) and/or video content to a consumer. The system can include many data stores of audio and/or video content which can be located and provided to the consumer based upon user preferences and attributes. The user's preferences and attributes can, for example, be used to define custom channels of content that may not fit into the typical music genres or categories of video content (movies and television shows). In addition, the user can provide feed back relating to one or more songs (or movies, videos) which the system can use to further update or modify the user's profile to further customize the user's channels. As stated above, a user's profile information and feedback information can also be correlated to advertising information in order to provide targeted advertising to users as well as assess the effectiveness of the advertising.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

What is claimed is

1. An online learning system providing users access to a plurality of educational information resources comprising:
an XML database adapted for storing educational information resources in a native XML format, each information resource including a plurality of information elements;
a relational database adapted for storing educational information resources, each information resource including a plurality of information elements;
an application server adapted for supporting the execution of applications, including applications adapted for searching and retrieving educational information elements from at least one of said XML database and said relational database; and
a web server adapted for receiving requests for access to said educational information resources from a user and for delivering at least one information elements to said user, said at least one information element being selected as a function of said request received from said user.

2. A system according to claim 1 further comprising means for locating, retrieving, formatting and assembling a plurality of educational information elements in response to said user request.

3. A system according to claim 2 wherein said educational standards information includes state standards.
